(19) United States
(12) Patent Application Publication
(10) Pub. No.: US 2010/0146931 A1
(43) Pub. Date: Jun. 17, 2010

(54) METHOD AND APPARATUS FOR IMPROVING EFFICIENCY OF A HALL EFFECT THRUSTER

(76) Inventors: Lyon Bradley King, Allouez, MI (US); Jason Sommerville, Houghton, MI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/623,787

(22) Filed: Nov. 23, 2009

Related U.S. Application Data
(60) Provisional application No. 61/118,306, filed on Nov. 26, 2008.

(51) Int. Cl. F03H 1/00; H05H 1/54

(52) U.S. Cl. 60/202

(57) ABSTRACT

A method of designing a plasma thruster with improved thrust efficiency. The method includes providing a thruster body having a discharge chamber with a first opening having an axis centrally located relative thereto; a cathode having a second opening at a first end thereof, the cathode being disposed at a radial position, relative to the axis, outside of the first opening; and an outer pole piece including a magnetic plate, the outer pole piece being adjacent to the first plane and extending radially outward, relative to the axis. At least one electromagnet is disposed adjacent to, and in magnetic communication with, the outer pole piece, a magnetic field being formed adjacent to the thruster body and the outer pole piece and having a separatrix surface therein. The magnetic field is altered such that the separatrix surface is moved radially outward relative to the axis toward the second opening.

### CROSS-REFERENCE TO RELATED APPLICATIONS

This application claims the benefit of U.S. Provisional Application No. 61/118,306, filed Nov. 26, 2008, which is incorporated herein by reference in its entirety.

### STATEMENT REGARDING FEDERALLY SPONSORED RESEARCH OR DEVELOPMENT

This invention was made with government support under contract number FA9550-05-1-0001 P00006 awarded by the U.S. Air Force Office of Scientific Research. The United States government has certain rights in the invention.

### FIELD OF THE INVENTION

The present invention relates to methods and apparatus for improving the efficiency of a Hall effect thruster.

### BACKGROUND OF THE INVENTION

Hall effect thrusters (HETs) are a class of plasma thrusters (sometimes referred to as “ion thrusters”), which are electric propulsion devices that use electric and magnetic fields to create a plasma and expel the ions at high velocity in order to generate thrust. A component of the HET is the cathode. The cathode is a plasma source which provides free electrons which serve, in some constructions, at least two purposes. The first purpose is beam neutralization: sufficient electrons are expelled via the cathode to balance the charge emitted by the ion beam. The second purpose is to provide the “seed” electrons which initialize and sustain the plasma discharge near the exit plane of the HET.

### SUMMARY OF THE INVENTION

In one construction, the invention is a Hall effect thruster including a thruster body including a discharge chamber, wherein the discharge chamber has a first opening therein, the first opening lying within a first plane, and an axis centrally located relative to the first opening and perpendicular to the first plane. The Hall effect thruster also includes a cathode having a second opening at a first end thereof, the cathode being disposed at a radial position, relative to the axis, outside of the first opening. The Hall effect thruster further includes an outer pole piece comprising a magnetic plate, the outer pole piece being adjacent to the first plane and extending radially outward, relative to the axis. The Hall effect thruster also includes at least one magnet disposed adjacent to, and in magnetic communication with, the outer pole piece, the at least one magnet projecting a footprint in a direction parallel to the axis onto the outer pole piece. A magnetic field is formed adjacent to the discharge chamber and the outer pole piece, the magnetic field having a separatrix surface therein, such that the separatrix surface and the first plane define a first volume, and the outer pole piece extends radially outward beyond the footprint of the at least one magnet, wherein the second opening lies within the first volume.

In another construction, the invention is a method of improving thrust efficiency in a Hall effect thruster. The method includes providing a thruster body having a discharge chamber, wherein the discharge chamber has a first opening therein, the first opening lying within a first plane, and an axis centrally located relative to the first opening and perpendicular to the first plane. The method also includes providing a cathode having a second opening at a first end thereof, the cathode being disposed at a radial position, relative to the axis, outside of the first opening. The method further includes situating the cathode at a radial position relative to the axis, away from the first opening. The method also includes providing an outer pole piece comprising a magnetic plate, the outer pole piece being adjacent to the discharge chamber and extending radially outward, relative to the axis. The method further includes disposing at least one magnet adjacent to, and in magnetic communication with, the outer pole piece, such that the outer pole piece extends radially outward beyond at least one magnet, at least one magnet projecting a footprint in a direction parallel to the axis onto the outer pole piece, a magnetic field being formed adjacent to the anode and the outer pole piece, the magnetic field having a separatrix surface therein. The method also includes disposing the second opening adjacent to or within the volume defined by the separatrix surface.

In yet another construction, the invention is a method of designing a plasma thruster with improved thrust efficiency. The method includes providing a thruster body having a discharge chamber, wherein the discharge chamber has a first opening therein, the first opening lying within a first plane, and an axis centrally located relative to the first opening and perpendicular to the first plane. The method also includes providing a cathode having a second opening at a first end thereof, the cathode being disposed at a radial position, relative to the axis, outside of the first opening. The method further includes providing an outer pole piece comprising a magnetic plate, the outer pole piece being adjacent to the first plane and extending radially outward, relative to the axis. The method also includes disposing at least one electromagnet adjacent to, and in magnetic communication with, the outer pole piece, a magnetic field being formed adjacent to the thruster body and the outer pole piece, the magnetic field having a separatrix surface therein. The method further includes altering the magnetic field such that the separatrix surface is moved outward in a radial direction relative to the axis toward the second opening.

### BRIEF DESCRIPTION OF THE DRAWINGS

FIG. 1 is a cross-sectional view through the central axis of a Hall effect thruster with magnetic field lines (solid lines) and separatrices (dotted lines) superimposed on the figure.

FIG. 2A shows a prior art (also referred to as herein as “original”) outer pole.

FIG. 2B shows an extended outer pole.

FIG. 3A shows a Hall effect thruster with the original outer pole mounted thereon.

FIG. 3B shows a Hall effect thruster with the extended outer pole mounted thereon.

FIG. 4A shows computed magnetic field lines and separatrices for a cross-section of a Hall effect thruster having either the original outer pole mounted thereon.

FIG. 4B shows computed magnetic field lines and separatrices for a cross-section of a Hall effect thruster having the extended outer pole mounted thereon.

FIG. 5A shows a cross-sectional view through a Hall effect thruster showing the cathode located adjacent to, and parallel to the plane of, the original outer pole.

FIG. 5B shows a cross-sectional view through a Hall effect thruster showing the cathode located adjacent to, and at an angle with respect to the plane of, the original outer pole.

FIG. 5C shows a cross-sectional view through a Hall effect thruster showing the cathode located adjacent to, and parallel to the plane of, the extended outer pole.

FIG. 6A shows an alternative construction of a Hall effect thruster in which the core of each magnet is modified so that the portion of each magnet that is nearer the outer pole piece flares outward in the radial direction.

FIG. 6B shows an alternative construction of a Hall effect thruster having a continuous, annular magnet surrounding the discharge chamber, wherein the portion of the magnet that is nearer the outer pole piece flares outward in the radial direction.

FIG. 6C shows an alternative construction of an outer pole piece which has been asymmetrically modified only in the region where the cathode is adjacent to the outer pole piece.

FIG. 6D shows an alternative construction of an outer pole piece in which a portion has been thickened and contoured to change the position of the separatrix surface.

FIGS. 7A-7E provide graphs showing comparisons of Hall effect thruster performance when operating using the original outer pole (dotted lines) and the extended outer pole (solid lines) under otherwise identical operating conditions.

### DETAILED DESCRIPTION

Before any constructions of the invention are explained in detail, it is to be understood that the invention is not limited in its application to the details of construction and the arrangement of components set forth in the following description or illustrated in the following drawings. The invention is capable of other constructions and of being practiced or of being carried out in various ways. Also, it is to be understood that the phraseology and terminology used herein is for the purpose of description and should not be regarded as limited. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Although directional references (e.g., front, rear, behind, etc.) may be made herein in describing the drawings, these references are made relative to the drawings (as normally viewed) for convenience. These directions are not intended to be taken literally or limit the invention in any form. In addition, terms such as “first,” “second,” and “third” are used herein for purposes of description and are not intended to indicate or imply relative importance or significance.

The process by which the free electrons in the plume of the cathode are coupled to the anode of a Hall effect thruster (HET), and how this process subsequently affects thruster performance, is not well understood. Researchers have studied the effects of a variety of cathode parameters such as design and mass flow rate on HET performance. It has been observed that cathode placement relative to the thruster has an effect on thruster performance. Further, the choice of operation parameters of the cathode can also have an effect on the efficiency with which an HET converts electrical power into thrust.

More specifically, it has been noted that cathodes mounted in the center of the thruster typically perform better than those with the cathode mounted in the traditional external locations. Unfortunately, center-mounted cathodes are predominantly feasible for larger HETs. Smaller thrusters (e.g. <2 kW), such as the BPT-2000 thruster offered by Aerojet Corp. (Sacramento, Calif., USA), often do not have sufficient room in their inner core for the cathode to be mounted internally. Therefore, testing for the optimal placement of the external cathode is still preferred.

However, because the coupling process remains largely unclear, determining the optimal cathode operation parameters is an expensive and time-consuming process. While measuring the performance of the thruster, the cathode parameters should be adjusted. This is particularly difficult for cathode placement, as it may require multiple tests, with the cathode being repositioned in between each test. Thus, a better understanding of the coupling processes enables reduction of the parameter space, including the range of cathode positions, that needs to be explored, thereby saving time and money in future HET development. An improved understanding of cathode coupling allows researchers to predict a priori which cathode positions are more likely to produce a HET with improved efficiency.

Experiments were conducted to measure the performance, particularly the efficiency, of a Hall effect thruster while adjusting the cathode position and mass flow rate. In addition to efficiency, other performance measurements include thrust, discharge current (for a fixed discharge voltage and anode mass flow), and cathode coupling voltage.

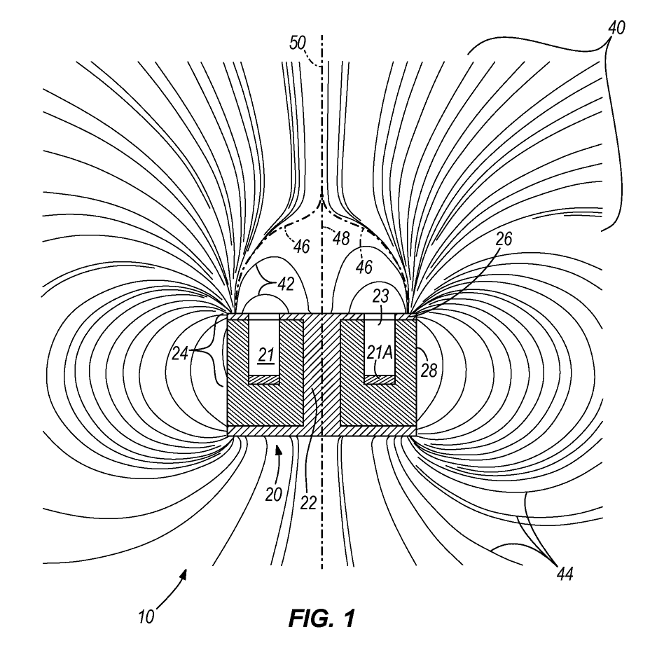

The results have been compared to the external magnetic field of the thruster and show the important role this field plays in the coupling process. In particular, we have found that many Hall effect thrusters include a “magnetic field separatrix” which is important to the performance of the thruster, helping to define regions of ‘good’ and ‘bad’ performance, which can be identified with knowledge of the thruster's external magnetic field. A typical Hall effect thruster 10 with an external cathode is shown in FIGS. 1 and 3A, for example. A Hall effect thruster 10 includes a thruster body 20 and a cathode 30. The thruster body 20 includes an inner magnetic pole 22 and an outer magnetic pole 24 having a discharge chamber 21 therebetween, the discharge chamber 21 having a first opening 23 and an anode 21A therein. In FIG. 3A the discharge chamber 21 is cylindrical and the first opening 23 is annular. However, other shapes for the first opening 23 include an elongated, squared-off oval or a linear shape, with the discharge chamber 21 having a cross-sectional shape similar to that of the first opening 23. The outer magnetic pole 24 includes an outer pole piece 26 (e.g. a magnetic iron plate) with one or more magnets 28 (e.g. electromagnets or permanent magnets) coupled thereto. The magnets 28 include an imaginary footprint 28a that is projected onto the outer pole piece 26 representing the outline of the body of each magnet 28. In the construction shown, the outer pole piece 26 is square with four straight outer edges 27, although other shapes are also possible. The outer pole piece 26 typically lies within a plane that is the same as, or parallel to, the plane of the first opening 23. A central axis 50 is centrally located with respect to the first opening 23, perpendicular to the plane(s) of the first opening 23 and the outer pole piece 26.

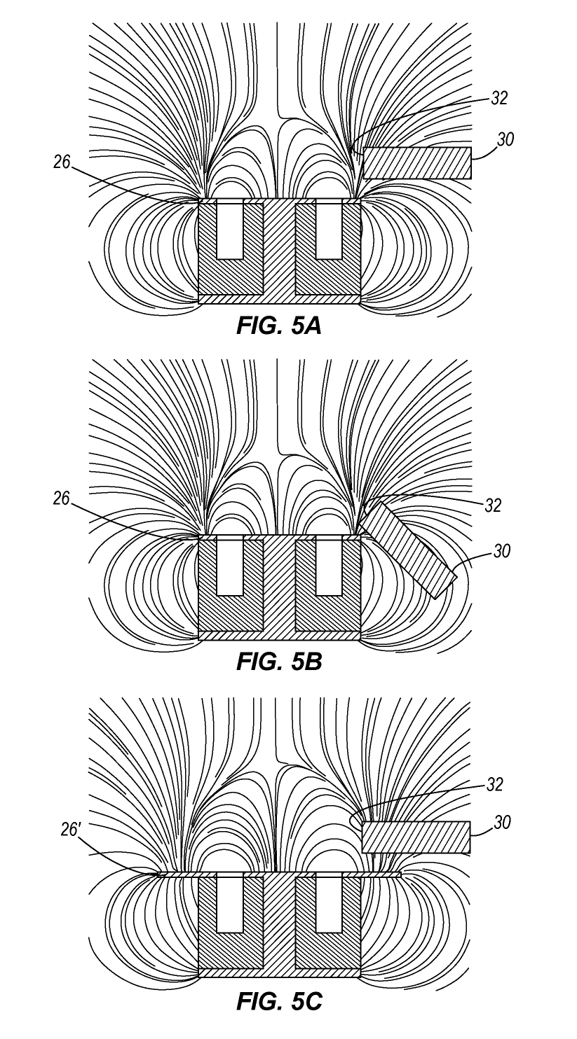

The cathode 30 is typically an elongated tube having an opening 32 at one end. The cathode 30 is positioned so that the opening 32 is near the outer magnetic pole 24 (e.g. Figures 5A, 5B, 5C). The cathode 30 may be positioned so that its body is parallel to the plane(s) of the first opening 23 and the outer pole piece 26 (original outer pole piece: FIG. 5A; extended outer pole piece: FIG. 5C) or at an angle with respect to the plane(s) of the first opening 23 and the outer pole piece 26 (FIG. 5B).

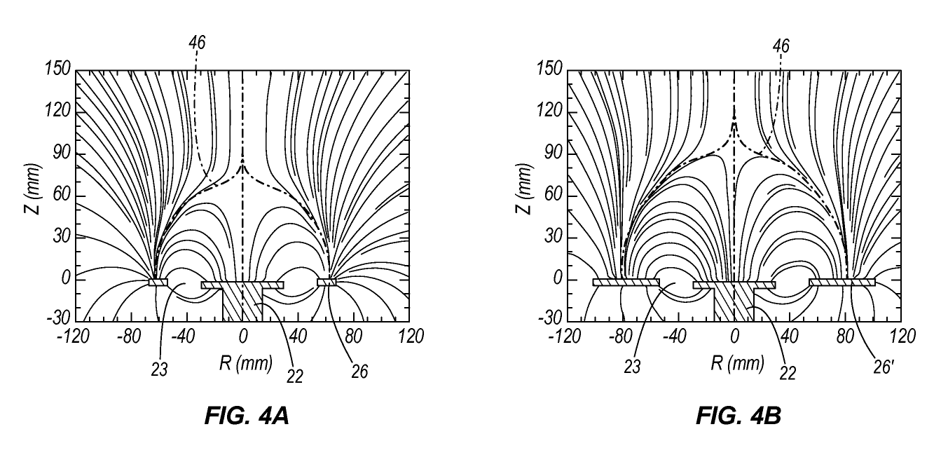

During operation, a magnetic field 40 (see FIGS. 1, 4A, and 4B) is created in and around the Hall effect thruster 10. As shown in FIGS. 1, 4A, and 4B, the magnetic field 40 includes local magnetic field lines 42 that form circuits between the inner 22 and outer 24 magnetic poles and which cross in front of the first opening 23, as well as other distal magnetic field lines 44 that form circuits outside the thruster 10. In between these two sets of field lines 42, 44 is a separatrix surface 46, which divides the local magnetic field lines 42 from the distal magnetic field lines 44. An additional separatrix line 48 is located along the central axis 50 of the thruster 10. Given the approximate radial symmetry of the illustrated thruster 10, the separatrix surface 46 is also approximately radially symmetrical about the central axis 50 of the thruster 10. In other constructions, for example using trim magnets and other methods as will be discussed below, the separatrix surface 46 is asymmetrical. The separatrix surface 46 begins at the planar face of the thruster 10, in particular from the outer pole piece 26, and terminates in a pointed region along the central axis 50, defining a volume containing the local magnetic field lines 42. The magnetic field lines 42, 44 and the location of the separatrix surface 46 can be determined either through computer simulation (as shown in FIGS. 1, 4A, and 4B) or by direct measurement.

In operation, a propellant gas, generally xenon or krypton, is ejected from the first opening 23 of the thruster 10 where it becomes ionized. The cathode 30 emits a plasma containing free electrons from the opening 32. The plasmas interact in the magnetic field 40 and the ions are accelerated to generate thrust. The accelerated ions are referred to as the ion beam, the ion beam having a cylindrical shape in the vicinity of the first opening 23.

The correlation between the magnetic field 40 and the performance data that was seen in the preliminary experiments suggested that magnetic fields are relevant in the coupling between the cathode 30 and the thruster body 20. FIG. 1 illustrates the magnetic field lines 42, 44 and a cross-section of the separatrices 46, 48 for a typical HET. Note that the local field lines 42 inside of the separatrix surface 46 tend to trap electrons in front of the first opening 23 of the thruster body 20 and in the ion beam. Meanwhile, field lines 44 outside of the separatrix surface 46 tend to direct electrons either to the rear of the thruster body 20, or away from the ion beam altogether. Combined with the correlation between magnetic field and performance, this suggests that the separatrix surface 46 is a potentially significant feature of the magnetic field 40 and that the cathode 30 should be located close to and, where possible, inside of, the separatrix surface 46, so as to introduce the electrons into a region that traps them in the beam, rather than in a region that pushes them away.

However, with a conventional setup, it was difficult to place the cathode 30 closer to or inside of the separatrix surface 46, as the cathode 30 would have collided with the thruster body 20. Instead, the cathode 30 was mounted at a 90 degree angle to the central axis 50 of the thruster 10 (e.g. as shown in FIGS. 5A, 5C). This allowed the cathode 30 to be moved in a radial direction closer to the central axis 50 and, in some constructions, to cross the separatrix surface 46. On small thrusters like the BPT-2000, it is not practical to cross the separatrix surface 46 without placing the cathode 30 near or in the path of the ion beam, which is emitted from the first opening 23. Locating the cathode 30 in or near the path of the ion beam, however, is not preferred for flight thrusters, as this configuration could result in high sputtering of the cathode orifice (i.e. the opening 32) and early cathode failure. On the BPT-2000, the separatrix surface 46 occurs at a position r=60 mm (FIG. 4A). However, the outer edge of the discharge chamber 21 has a radius of 50 mm. Thus, for a cathode 30 mounted at 90 degrees to the thrust axis 50 with its center line at an axial distance of z=30 mm downstream of the face, even if the cathode 30 is placed exactly at the separatrix surface 46, this is 10 mm or less away from the ion beam, which may be considered too close to the ion beam.

As part of the testing procedure, the cathode 30 was moved across the separatrix surface 46 and into the path of the ion beam, i.e. in front of the first opening 23 of the thruster body 20. As determined experimentally, the optimal position for the cathode 30 to provide the highest possible thrust efficiency 30 is inside of the volume defined by the separatrix surface 46 and the plane of the front face of the thruster body 20. As noted above, however, moving the cathode 30 in the vicinity of the separatrix surface 46 can cause sputtering of the cathode 30. Thus, the position of the separatrix surface 46 was altered in order to facilitate adjustment of the position of the cathode 30 in the region of the separatrix surface 46 without placing the cathode 30 too close to the path of the ion beam. That is, the magnetic fields are manipulated so as to move the position of the separatrix surface 46 away from the first opening 23, at least in the vicinity of the cathode 30, to facilitate positioning of the opening 32 of the cathode 30 between the separatrix surface 46 and the outer edge of the first opening 23. In some constructions, the separatrix surface 46 is moved radially outward a sufficient distance so that the opening 32 of the cathode 30 is placed inside of the separatrix surface 46 (i.e. the opening 32 is closer to the central axis 50 than the separatrix surface 46). In other constructions, the separatrix 46 is moved closer to the cathode opening 32, but does not cross it (i.e. the opening 32 is further from the central axis 50 than the separatrix surface 46). In still other constructions, the separatrix surface 46 is approximately aligned with the cathode opening 32 (i.e. the opening 32 and the separatrix surface 46 area at approximately the same radial distance from the central axis 50).

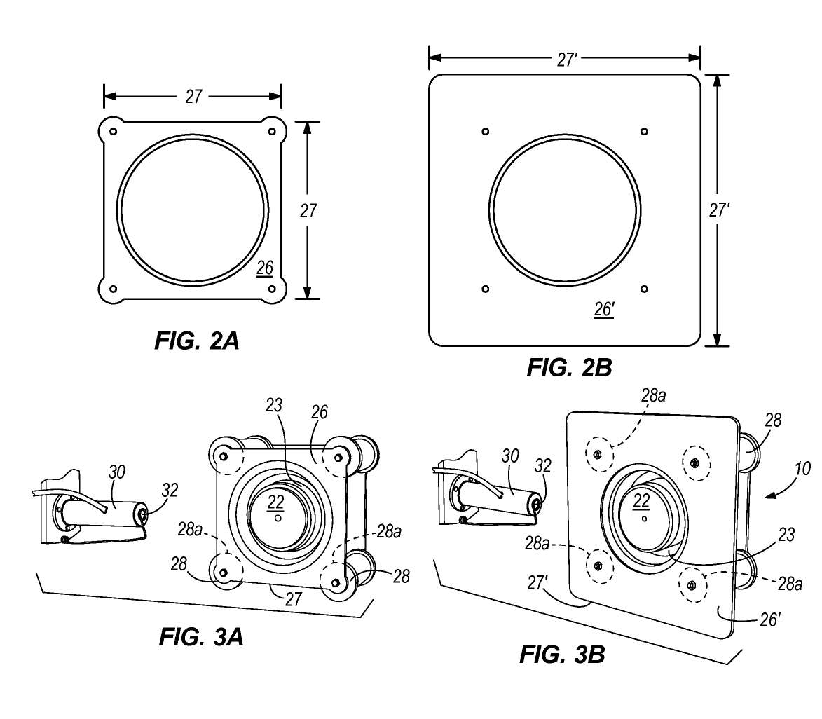

In one construction, outward movement of the position of the separatrix surface 46 was accomplished by providing an extended outer pole piece 26′ (FIGS. 2B, 3B, 4B, 5C). The extended outer pole piece 26′ has larger outer edges 27′ than the original outer pole piece 26, such that the extended outer pole piece 26′ extends beyond the footprints 28a of the magnets 28. In one construction, an extended outer pole piece 26′ was designed in which the length of each outer edge 27′ was extended by 70 mm, while the other dimensions of the original pole piece 26 remained unchanged. In the examples discussed herein, the extended outer pole piece 26′ is made from ASTM-A848 magnet iron, although other suitable materials could be used instead. FIG. 2 shows a drawing of the original 26 (FIG. 2A) and the extended 26′ (FIG. 2B) outer pole piece. FIG. 3 shows a photograph of the original 26 (FIG. 3A) and the extended 26′ (FIG. 3B) outer pole piece mounted to the thruster 10. As shown in FIGS. 4A and 4B, the calculated magnetic field 40 of the thruster 10 is modified such that at z=30 mm the separatrix surface 46 occurs at 78 mm from the central axis 50 (FIG. 4B), 18 mm further than with the original pole piece 26 (FIG. 4A). A consequence of using the extended outer pole piece 26′ is that the magnetic field is modified in the discharge chamber 21, e.g. in the vicinity of the first opening 23. This is most evident near the inner edge of each outer pole piece 26, 26′, where the shape of the field strength contours have changed noticeably (e.g. compare FIG. 4A to FIG. 4B).

Thus, in the example shown in FIGS. 2-4, the extended outer pole piece 26′ is 35 mm longer in the radial direction (measured midway between the corners of the square pole piece, FIGS. 2A and 2B) than the original outer pole piece 26, and is approximately 50% longer along the outer edges. In other constructions, the dimensions of the extended outer pole piece 26′ can be increased by any amount, for example in one particular construction the extended outer pole piece 26′ is 50 mm longer in the radial direction, or 75% longer along the outer edges.

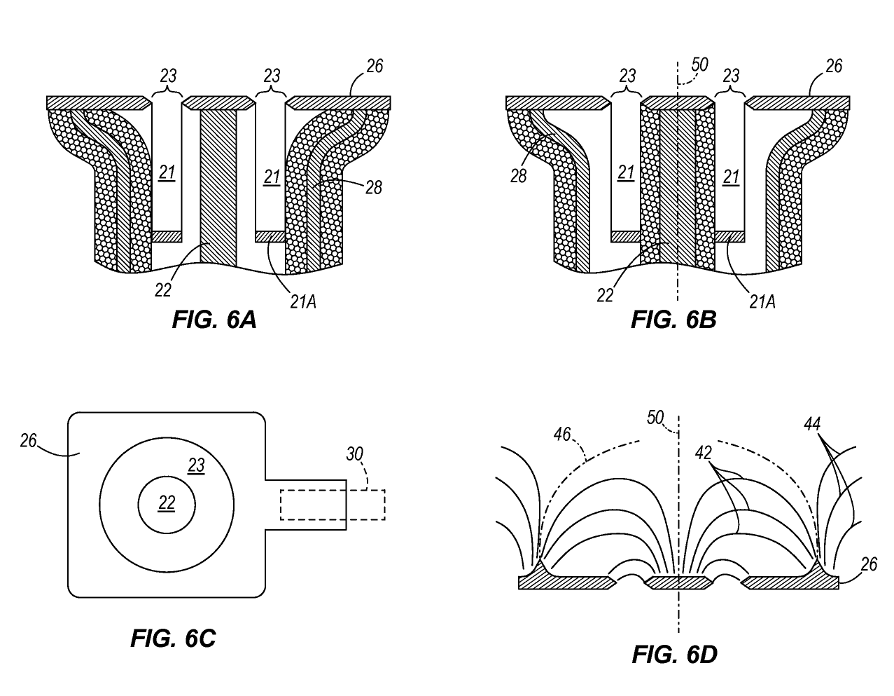

In some constructions, the outer pole piece 26 is made to be thicker, either throughout the plate or in certain regions. In other constructions, the outer pole piece 26 is thickened and contoured (FIG. 6D) to change the position of the separatrix surface 46. In yet other constructions, the core of the magnet 28 is modified so that the portion of the magnet 28 that is nearer the outer pole piece 26 flares outward in the radial direction (FIG. 6A). In one particular construction, the magnet 28 may be a continuous, annular magnet (e.g. an electromagnet) (FIG. 6B), rather than a group of single magnets as in FIG. 6A. In the various constructions discussed herein in which steps are taken to alter the separatrix surface 46, consideration should be given to the effect the alterations have on the internal magnetic fields of the thruster 10.

In other constructions, the shape of the extended pole piece 26′ is altered in order to modify the position of the separatrix surface 46. In still other constructions, the position of the separatrix surface 46 is altered by changing the numbers, properties (including, e.g., the coil currents), and/or positions of the magnets 28. In one construction, additional ‘trim’ magnets are added to the thruster body 20. In yet other constructions, the positions of the magnets 28 are altered, with or without the use of an extended pole piece 26′, in order to adjust the location of the separatrix surface 46.

While in most instances the outer pole piece 26 is designed to produce a separatrix surface 46 having approximately radial symmetry, in certain constructions the extended pole piece 26′ is asymmetrically altered, e.g. only in the region where the cathode 30 is adjacent to the outer pole piece 26 of the thruster body 20 (FIG. 6C). In still other constructions, an opening may be made in the extended pole piece 26′ to accommodate the cathode 30, so that the cathode 30 can be positioned closer to the annular opening 23. Although the drawings show a square outer pole piece 26, in various constructions other shapes are used as well, such as circular, hexagonal, octagonal, or other shapes.

To quantify the efficiency improvement associated with use of the extended outer pole piece 26′, experiments were performed to directly compare the performance of the Hall effect thruster 10 with the original outer pole (OOP) piece 26 and the extended outer pole (EOP) piece 26′ shown in FIGS. 2-4. The cathode 30 was positioned at z=30 mm, r=70 mm, roughly halfway between the separatrix on the OOP and that of the EOP at z=30 mm. In this position, the thruster was operated in the standard fashion with the EOP mounted. The thruster 10 was operated with krypton as the propellant at a voltage of V=250 V and an anode mass flow rate of \dot{m}=41 standard cubic centimeters per minute (SCCM) (4 mg/s Xe equivalent).

Once the thruster had reached steady-state operation, the magnet current was varied over a range of values which included the optimal value of ˜1.3 A. The cathode mass flow rate was also varied between the three values used in the prior experiment: 2, 5, and 10 SCCM. The thrust, discharge current, cathode coupling voltage and efficiency, along with the rest of the standard telemetry data, were measured using standard techniques.

After this experiment was performed, the EOP was replaced with the OOP, which required bringing the vacuum chamber up to atmosphere. After switching the outer poles, the chamber was re-evacuated and the experiment repeated.

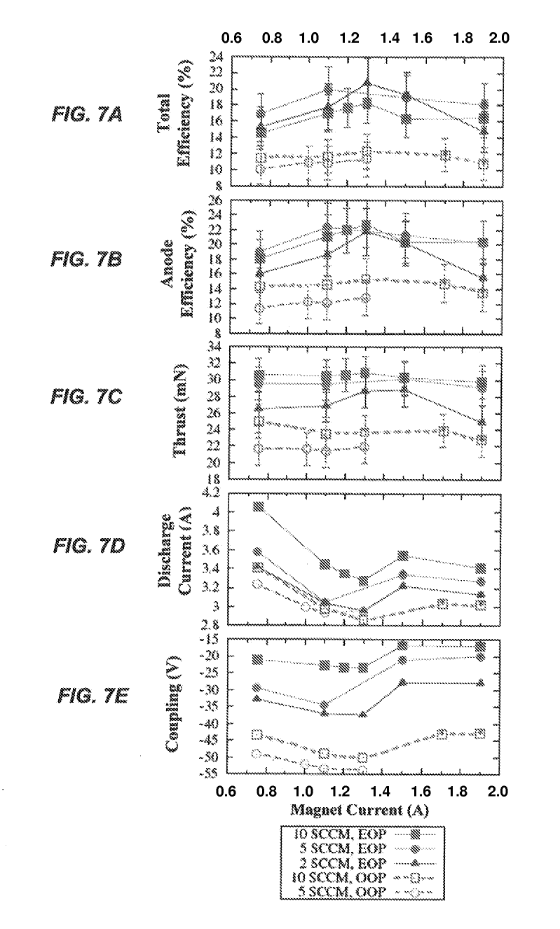

FIGS. 7A-7E show the results of the experiment as a function of magnet current. FIGS. 7A and 7B show total and anode efficiencies respectively. FIGS. 7C and 7D show the measurements of thrust and discharge current from which the efficiencies are derived according to equations (1) and (2):

$$\begin{matrix}{η}_{a} = \frac{{T}^{2}}{2 {\dot{m}}_{a} {I}_{d} {V}_{d}} & ( 1 ) \\ {η}_{t} = \frac{{T}^{2}}{2 ( {\dot{m}}_{a} + {\dot{m}}_{c} ) {I}_{d} {V}_{d}} & ( 2 )\end{matrix}$$

FIG. 7E shows the cathode coupling voltages. The different cathode mass flow rates are shown as triangles (2 SCCM), circles (5 SCCM), and squares (10 SCCM). Solid markers and lines denote data from the EOP, while open markers and dashed lines denote data from the OOP. With the OOP, the thruster would not operate stably at the 2 SCCM cathode flow rate, nor at any level of current through the magnet coils (I_{mag}) greater than 1.3 A when the cathode mass flow rate (\dot{m}_{c}) was 5 SCCM.

The errors are estimated as discussed below in the Appendix, with the error on the thrust measurements estimated at 2 mN (milliNewtons). This yields errors in the efficiencies of about 2.5 percentage points.

It can be seen from FIGS. 7A-7E that the EOP improved the efficiency of the thruster. The figure shows that the efficiency with the EOP is five to ten percentage points greater than the efficiency with the OOP. The data suggest that the increased efficiency of the EOP is due to the cathode being inside the separatrix. The cathode coupling voltages for the OOP data are ˜25 V lower than with the EOP, corresponding to coupling efficiencies on the ˜80% for the OOP rather than >90% for the EOP, indicating that the coupling is improved.

### APPENDIX

The uncertainty in the thrust measurements is estimated at 2 mN based on observations of the remaining drifts in the thrust stand. The uncertainty in the efficiencies are calculated according to the standard method. For a function f (a;b), the variance (i.e. the square of the uncertainty) is given by:

$${σ}_{f}^{2} = {( \frac{\partial f}{\partial a} )}^{2} {σ}_{a}^{2} + {( \frac{\partial f}{\partial b} )}^{2} {σ}_{b}^{2} \qquad ( 3 )$$

Recall the equation for thrust:

$$η = \frac{{T}^{2}}{2 \dot{m} {I}_{d} {V}_{d}} . \qquad ( 4 )$$

Since the uncertainties in I_{d} and V_{d} are negligible, variance in the efficiency is given by:

$$\begin{matrix}{σ}_{η}^{2} = {( \frac{T}{\dot{m} P} )}^{2} {σ}_{T}^{2} + {( \frac{T}{2 {\dot{m}}^{2} P} )}^{2} {σ}_{\dot{m}}^{2} & ( 5 ) \\ = {η}^{2} ( \frac{4 {σ}_{T}^{2}}{{T}^{2}} + \frac{{σ}_{\dot{m}}^{2}}{{\dot{m}}^{2}} ) & ( 6 )\end{matrix}$$

Therefore the uncertainty is given by:

$${σ}_{η} = η \sqrt{\frac{4 {σ}_{T}^{2}}{{T}^{2}} + \frac{{σ}_{\dot{m}}^{2}}{{\dot{m}}^{2}}} . \qquad ( 7 )$$

For anode efficiencies, \dot{m}=\dot{m}ₐ and equation (6) may be used directly. For total efficiencies one must substitute \dot{m}=\dot{m}ₐ+\dot{m}_{c}. The variance of this quantity is given by:

σ_{\dot{m}}²=σ_{\dot{m}}_{ₐ}²+σ\dot{m}_{_{c}}² (8)

The uncertainty in the mass flow is 1% of the full scale range of the mass flow controller. This yields 2 SCCM for the anode mass flow controller, and 0.2 SCCM for the cathode flow controller.

What is claimed is:

1. A Hall effect thruster comprising:
a thruster body comprising a discharge chamber, wherein the discharge chamber has a first opening therein, the first opening lying within a first plane, and an axis centrally located relative to the first opening and perpendicular to the first plane;
a cathode having a second opening at a first end thereof, the cathode being disposed at a radial position, relative to the axis, outside of the first opening;
an outer pole piece comprising a magnetic plate, the outer pole piece being adjacent to the first plane and extending radially outward, relative to the axis; and
at least one magnet disposed adjacent to, and in magnetic communication with, the outer pole piece, the at least one magnet projecting a footprint in a direction parallel to the axis onto the outer pole piece;
wherein a magnetic field is formed adjacent to the discharge chamber and the outer pole piece, the magnetic field having a separatrix surface therein, such that the separatrix surface and the first plane define a first volume,
wherein the outer pole piece extends radially outward beyond the footprint of the at least one magnet,
wherein the second opening lies within the first volume.

2. The Hall effect thruster of claim 1, wherein the first opening is an annulus, and the axis extends from the center point of the annulus.

3. A method of improving thrust efficiency in a Hall effect thruster, the method comprising:
providing a thruster body comprising a discharge chamber, wherein the discharge chamber has a first opening therein, the first opening lying within a first plane, and an axis centrally located relative to the first opening and perpendicular to the first plane;
providing a cathode having a second opening at a first end thereof, the cathode being disposed at a radial position, relative to the axis, outside of the first opening;
situating the cathode at a radial position relative to the axis, away from the first opening;
providing an outer pole piece comprising a magnetic plate, the outer pole piece being adjacent to the discharge chamber and extending radially outward, relative to the axis;
disposing at least one magnet adjacent to, and in magnetic communication with, the outer pole piece, such that the outer pole piece extends radially outward beyond the at least one magnet, the at least one magnet projecting a footprint in a direction parallel to the axis onto the outer pole piece, a magnetic field being formed adjacent to the anode and the outer pole piece, the magnetic field having a separatrix surface therein; and
disposing the second opening adjacent to the separatrix surface.

4. The method of claim 3, wherein the first opening is an annulus, and the axis extends from the center point of the annulus.

5. The method of claim 3, further comprising determining a location of the separatrix surface.

6. The method of claim 5, further comprising adjusting a position of the cathode such that the second opening is disposed adjacent to the separatrix surface.

7. The method of claim 5, further comprising adjusting a position of the cathode such that the second opening is disposed within a volume defined by the separatrix surface and the first plane.

8. The method of claim 3, further comprising altering the magnetic field so that the second opening is located within a volume defined by the separatrix surface and the first plane.

9. A method of designing a plasma thruster with improved thrust efficiency, the method comprising:
providing a thruster body comprising a discharge chamber, wherein the discharge chamber has a first opening therein, the first opening lying within a first plane, and an axis centrally located relative to the first opening and perpendicular to the first plane;
providing a cathode having a second opening at a first end thereof, the cathode being disposed at a radial position, relative to the axis, outside of the first opening;
providing an outer pole piece comprising a magnetic plate, the outer pole piece being adjacent to the first plane and extending radially outward, relative to the axis;
disposing at least one electromagnet adjacent to, and in magnetic communication with, the outer pole piece, a magnetic field being formed adjacent to the thruster body and the outer pole piece, the magnetic field having a separatrix surface therein; and
altering the magnetic field such that the separatrix surface is moved outward in a radial direction relative to the axis toward the second opening.

10. The method of claim 9, wherein the first opening is an annulus, and the axis extends from the center point of the annulus.

11. The method of claim 9, further comprising determining a location of the separatrix surface.

12. The method of claim 11, further comprising adjusting a position of the cathode such that the second opening is disposed adjacent to the separatrix surface.

13. The method of claim 11, further comprising adjusting a position of the cathode such that the second opening is disposed within a volume defined by the separatrix surface and the first plane.

14. The method of claim 9, further comprising altering the magnetic field so that the second opening is located within a volume defined by the separatrix surface and the first plane.
